(19) United States
(12) Patent Application Publication
(10) Pub. No.: US 2023/0390730 A1
(43) Pub. Date: Dec. 7, 2023

(54) METHOD OF USING AN ALUMINA IN A MOLYBDENUM/TECHNETIUM-99m GENERATOR

(71) Applicant: BWXT Isotope Technology Group, Inc., Lynchburg, VA (US)

(72) Inventors: Bryan Blake WIGGINS, Forest, VA (US); Christopher Sean FEWOX, Forest, VA (US); Timothy A. POLICKE, Forest, VA (US); Benjamin Isaiah BISHOP, Charlotte, NC (US)

(21) Appl. No.: 18/204,049

(22) Filed: May 31, 2023

Related U.S. Application Data
(60) Provisional application No. 63/348,613, filed on Jun. 3, 2022.

(51) Int. Cl. B01J 20/08; B01J 20/02; B01J 20/284; B01J 20/30

(52) U.S. Cl. CPC B01J 20/08; B01J 20/0218; B01J 20/284; B01J 20/3092; B01J 2220/42; B01J 2220/56; B01J 2220/58

(57) ABSTRACT

A Molybdenum/Technetium 99-m generator containing a metal-molybdate containing powder and an alumina sorbent. A preferred alumina sorbent is a gamma-phase alumina (γ-Al₂O₃), a chi-phase alumina (χ-Al₂O₃), or a combination thereof.

### CROSS-REFERENCE TO RELATED APPLICATIONS

This application claims priority from U.S. Provisional Patent Application No. 63/348,613 filed on Jun. 3, 2022, in the United States Patent and Trademark Office. The disclosure of which is incorporated herein by reference in its entirety.

### FIELD OF THE INVENTION

The present invention relates to a method of using an alumina as a guard filter in a Molybdenum/Technetium 99-m (Mo/Tc-99m) generator, more particularly to a method of using an alumina as a guard filter in a Molybdenum/Technetium 99-m generator having a metal-molybdate containing powder.

### BACKGROUND OF THE INVENTION

Technetium-99m (Tc-99m) is the most commonly used radioisotope in nuclear medicine (e.g., medical diagnostic imaging). Tc-99m (m is metastable) is typically injected into a patient which, when used with certain equipment, is used to image the patient's internal organs. However, Tc-99m has a half-life of only about six (6) hours. As such, readily available sources of Tc-99m are of particular interest and/or need in at least the nuclear medicine field.

Given the short half-life of Tc-99m, Tc-99m is typically obtained at the location and/or time of need (e.g., at a pharmacy, hospital, etc.) via a Mo/Tc-99m generator. Mo/Tc-99m generators are devices used to extract the metastable isotope of technetium (i.e., Tc-99m) from a source of decaying molybdenum (typically Mo-99) by passing saline through the Mo material. Mo-99 is unstable and decays with an about 66-hour half-life to Tc-99m. Mo-99 is typically produced in a high-flux nuclear reactor from the irradiation of highly-enriched uranium targets (93% Uranium-235) and shipped to Mo/Tc-99m generator manufacturing sites. This is a conventional method to produce Mo-99 in which the Mo breakthrough is typically only Mo-99 produced from the fission of uranium. Mo breakthrough is an even much more significant concern when the Mo is not only Mo-99 but all Mo where the source is typically natural Mo.

Mo/Tc-99m generators are then distributed from these centralized locations to hospitals and pharmacies throughout the country. Since the number of production sites are limited and compounded by the limited number of available high flux nuclear reactors, the supply of Mo-99 is susceptible to frequent interruptions and shortages resulting in delayed nuclear medicine procedures.

Molybdenum, in both the radiological and chemical form, is considered a contaminant in the eluate. The Mo/Tc-99m generators currently on the market use an aluminum oxide sorbent (Brockmann I alumina sorbent) with the chemical structure of α-Al₂O₃. If Mo-99 is pulled into the eluate along with the sodium pertechnetate, Mo-99 has broken through the ion/anion separation process.

It is important to block the draw of Mo-99 into the solution that is tagged to a pharmaceutical drug injected into the human body. If unmitigated, Mo-99 could expose patients to potentially high and unnecessary doses of radiation.

The conventional way to produce a Mo/Tc-99m generator involves the use of column chemistry to function. With conventional generators, the molybdate species is doubly negatively charged (−2) and when it decays the Tc-99m daughter is singly negatively charged and is not bound (or sorbed) to the Al₂O₃ and can be eluted off with the saline solution that traverses the Al₂O₃ column. FIG. 1 illustrates a prior art conventional Mo/Tc-99m generator. As shown in FIG. 1, in step 1, Mo-99 in the molybdate (MoO₄²⁻) liquid phase, is adsorbed to an acid activated alumina (Al₂O₃) column. Mo-99 then decays to its daughter, Tc-99m, which is less tightly bound to the alumina column. As shown in step 2 of FIG. 1, elutions with saline are efficient with releasing the pertechnetate (TcO4−) ion, while keeping the Mo immobilized.

When using traditional alumina sorbents from Mo/Tc-99m generator technology, the aluminum oxide sorbent (Brockmann I alumina) with the chemical structure of α-Al₂O₃, would require an equal mass ratio of alumina to powder to adequately reduce the issue of Mo breakthrough. FIG. 2 illustrates the morphology of Brockmann I alumina (α-Al₂O₃).

Use of Brockmann I alumina (α-Al₂O₃) as a sorbent will lead to disadvantageous issues for the Mo/Tc-99m generators in terms of poor elution efficiency, shielding with the alumina bed, high mass requirements, and greater size dimensions of the generator.

Thus, there is a need to find a suitable alternative to address Mo breakthrough and alleviate the above concerns when using a molybdenum/technetium-99m (Tc-99m) generator having a metal-molybdate containing powder material.

### SUMMARY OF THE INVENTION

The present invention relates to a system and a method of using an alumina such as gamma-phase aluminum oxide (γ-Al₂O₃), chi-phase aluminum oxide (χ-Al₂O₃), or a combination thereof, as a prevention or guard filter in a molybdenum (Mo)/technetium-99m (Tc-99m) generator, preferably in a Mo/Tc-99m generator having a metal-molybdate containing powder. Gamma-phase aluminum oxide (γ-Al₂O₃) and/or chi-phase aluminum oxide (χ-Al₂O₃) can be acidic, basic, or neutral. The term “guard filter”, as used herein, generally refers to the alumina being used as a physical/mechanical barrier as opposed to a sorbent.

The present invention uses the alumina as a guard filter to control the amount of impurities (including soluble Mo species) reporting to the eluate. Mo breakthrough is an inherent challenge to Molybdenum/Technetium-99m (Tc-99m) generators, but more particularly for Molybdenum (non-Uranium) production of Mo-99. The method of the present invention addresses Mo breakthrough. The method of the present invention also addresses the chemical and radiological purity of the powder to identify the radioisotope impurities that need to be mitigated to create a cleaner powder for use in the final pharmaceutical product. The method of the present invention not only uses alumina as a guard filter to prevent or mitigate breakthrough of Mo, but also to prevent or mitigate breakthrough of other radioisotopes and other chemical impurities such as one or more of the following: Be, Li, Ti, V, Cr, Mn, Co, Ni, Cu, Zn, Ru, Rh, Pd, Ag, Cd, Sn, Ba, W, Ir, Pt, Au, Tl, Pb. The guard filter preferably has a pH in a range of 3.5 to 7.5, preferably 3.5 to 5.

In an embodiment of the invention, the method comprises passing an elution through a Molybdenum/Technetium-99m generator, preferably a Molybdenum/Technetium-99m generator having a metal-molybdate containing powder, and selectively filtering the molybdate and/or other radioisotope impurities using a prevention filter of alumina, preferably γ-Al₂O₃ and/or χ-Al₂O₃. The γ-Al₂O₃ and x-Al₂O₃ may, for example, may have microcrystalline or nanocrystalline particle sizes. Alpha-phase alumina can be used in combination with γ-Al₂O₃ and/or χ-Al₂O₃.

Among the other features of the alumina that may be used, the alumina has a moisture content of less than 3.5 weight percent based on the weight of the alumina. The alumina has a surface area of greater than or equal to 140 m²/g. The alumina may vary in its particle size distribution.

In an embodiment of the invention, a mass ratio of chi-phase alumina to metal-molybdate powder (Al:P) in a range of 0.025:1 (Al:P) to 5:1 (Al:P) may be used to filter Mo from the metal-molybdate containing powder in a generator.

In an embodiment of the invention, a mass ratio of gamma-phase alumina to metal-molybdate powder (Al:P) in a range of 0.025:1 (Al:P) to 5:1 (Al:P) may be used to efficiently filter Mo from the metal-molybdate containing powder in a generator.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 illustrates a prior art conventional Mo/Tc-99m generator.

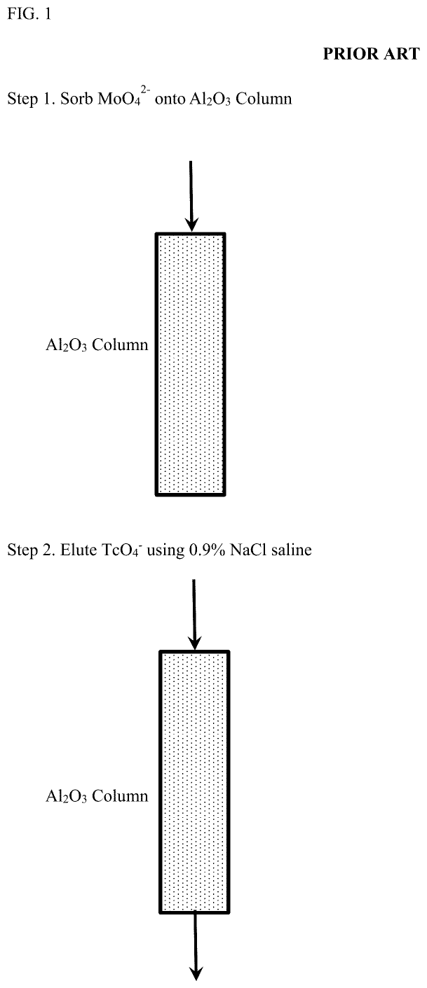

FIG. 2 illustrates the morphology of Brockmann I alumina (α-Al₂O₃).

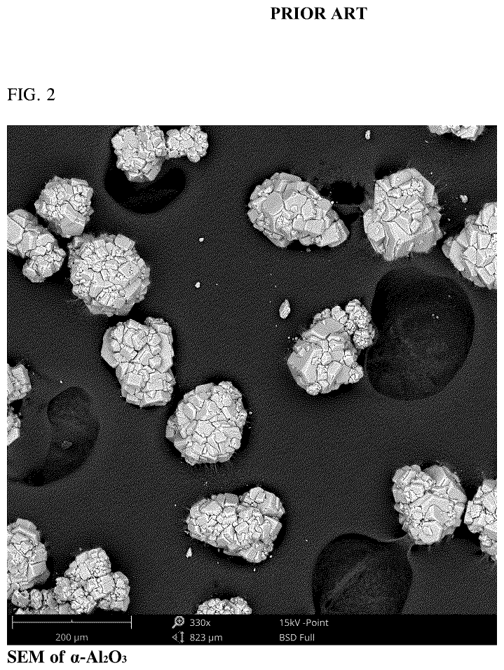

FIG. 3 illustrates a Mo/Tc-99m generator in accordance with an aspect of the present invention.

FIG. 4 illustrates the morphology of a gamma alumina (γ-Al₂O₃) that may be used in accordance with the present invention.

FIG. 5 illustrates the morphology of a chi-phase aluminum oxide (χ-Al₂O₃) that may be used in accordance with the present invention.

### DESCRIPTION OF THE PREFERRED EMBODIMENTS

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The term “metal-molybdate” (also referred to herein as metal-Mo), as used herein, generally refers to either a metal-molybdate, metal-molybdenum, molybdenum-metalate, or any form of Mo-metal or metal-Mo species.

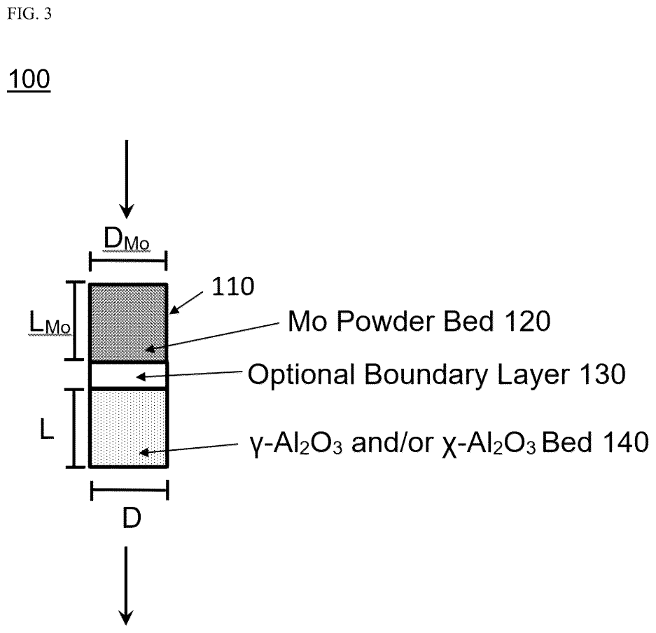

FIG. 3 illustrates a Mo/Tc-99m generator 100 in accordance with an embodiment of the present invention. As shown in FIG. 3, Mo/Tc-99m generator 100 has one or more columns 110, the one or more columns 110 having a Mo powder-containing bed 120 having a length-to-diameter (L_{Mo}/D_{Mo}) ratio, an optional boundary layer 130 to prevent particle migration, and a guard filter material-containing bed (γ-Al₂O₃ or χ-Al₂O₃ shown) 140 having a length-to-diameter (L/D) ratio. Using Mo/Tc-99m generator 100, TcO₄₋ is eluted using 0.9% NaCl saline, for example. Boundary layer 130 is a separator used to control fine powder from migrating from one layer to the next. Boundary layer 130 may comprise alumina oxide, PVDF (polyvinylidene difluoride), PES (polyethersulfone), MCE (mixed cellulose ester), or glass microfibers.

In an embodiment of the present invention, a Mo/Tc-99m generator has a column with a guard filter material-containing bed height (Length) and a column inner diameter (D). Preferably, the length-to-diameter (LID) ratio is in a range of 0.25 to 10 to exhibit a desirable filtering performance in terms of molybdenum (Mo) breakthrough. Filtering is important because it blocks the draw of Mo into solution that is tagged to a pharmaceutical drug injected into the human body. If unmitigated, Mo could expose patients to potentially high and unnecessary doses of radiation.

In an embodiment of the present invention, a Mo/Tc-99m generator comprises a metal-molybdate powder and an alumina as a guard filter. Elutions pass through a bed of the metal-molybdate powder and elute both Mo and Tc. The Mo is selectively purified using the alumina as the guard or prevention filter to reduce Mo breakthrough.

The guard filter is an alumina, preferably, gamma-phase alumina (γ-Al₂O₃), chi-phase alumina (χ-Al₂O₃), or a combination thereof. Alpha-phase alumina (α-Al₂O₃) can be used in combination with γ-Al₂O₃ and/or χ-Al₂O₃. Alternatively, other guard filter materials that do not appreciably sorb the desired TcO₄₋ but sorb the unwanted Mo species and other undesired impurities may be used in combination with γ-Al₂O₃ and/or χ-Al₂O₃ and are selected from the group consisting of, MSU-X mesoporous alumina, Polymeric Titania Compound (PTC), Polymer Embedded Nanocrystalline Titania, Polymeric Zirconia Compound (PZC), Tetragonal Nano Zirconia, chitosan-based products, iron, and activated carbon.

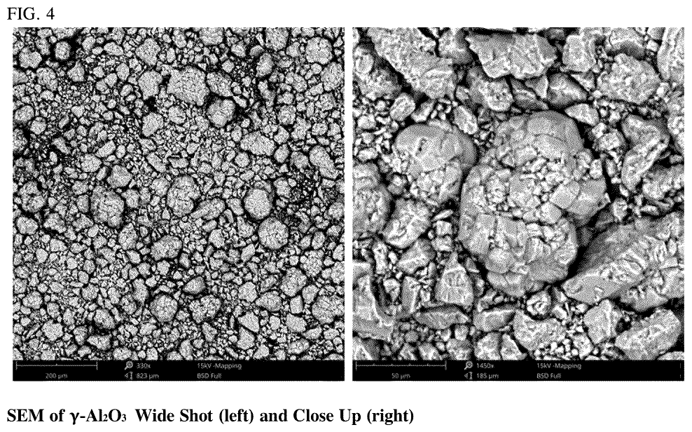

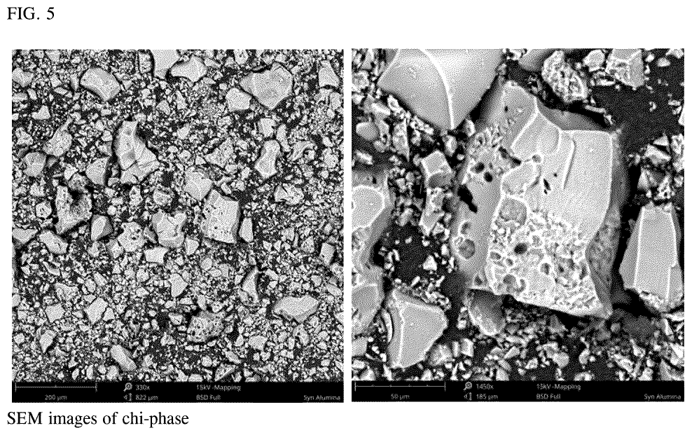

An advantage of using γ-Al₂O₃ or χ-Al₂O₃ is the reduction in major impurities. Although elution time with γ-Al₂O₃ or χ-Al₂O₃ may vary, elution time should be as low as reasonably achievable. Elution time is expected to be less than 10 minutes, preferably less than 5 minutes. FIG. 4 illustrates the morphology of a gamma-phase alumina (γ-Al₂O₃) that may be used in accordance with the present invention. FIG. 5 illustrates the morphology of a chi-phase aluminum oxide (χ-Al₂O₃) that may be used in accordance with the present invention.

In an embodiment of the invention, a mass ratio of gamma-phase alumina to metal-molybdate powder (Al:P) in a range of 0.025:1 (Al:P) to 5:1 (Al:P) may be used to efficiently filter Mo from the metal-molybdate containing powder in a generator.

In an embodiment of the invention, a mass ratio of chi-phase alumina to metal-molybdate powder (Al:P) in a range of 0.025:1 (Al:P) to 5:1 (Al:P) may be used to filter Mo from the metal-molybdate containing powder in a generator.

In an embodiment of the present invention, the release of Tc-99m meets the United States Pharmacopeia (USP) monograph standards for “Sodium Pertechnetate Tc-99m Injection.” In an embodiment of the present invention, there is an efficient release of Tc-99m and thereby meeting the USP specification for radiopurity in which the ratio of Mo to Tc-99m must be less than (<) 0.15 μCi/mCi.

### Comparative Example

TABLE 1

| Alumina | Al:P Ratio | Tc-99m Yield (%) |
|---|---|---|
| Brockmann I series, acid | 1A1:1P | 16 |
| activated | | |
| α-Al₂O₃ | | |
| Brockmann I series, acid | 0.5Al:1P Ratio | 35 |
| activated | | |
| α-Al₂O₃ | | |
| γ-Al₂O₃ | 0.1Al:1P Ratio | 89 |
| χ-Al₂O₃ | 0.1Al:1P Ratio | 89 |

The data in Table 1 suggested that the Brockmann I sorbent is too inefficient with the highest Tc-99m yield at only 35%. The γ-Al₂O₃ and the χ-Al₂O₃, however, yielded 89% Tc-99m. Moreover, the γ-Al₂O₃ and the χ-Al₂O₃ achieved the highest yield with a ratio of Al₂O₃ to Powder of 0.1:1. The γ-Al₂O₃ and the χ-Al₂O₃ performed better using far less material than the Brockmann I sorbent. Thus, it was concluded that traditional alumina will have poor elution efficiency when using the powder bed.

### Example

The following test was conducted. Chromatography columns having the guard filters listed in Table 2 were eluted, and a L/D of each guard filter was measured. Measurements are shown in Table 2.

TABLE 2

| | Bed Height | Inner Diameter | |
|---|---|---|---|
| Column | (mm) | (mm) | L/D |
| γ-Al₂O₃ | 53.36 | 19.9 | 2.68 |
| (literature) | | | |
| γ-Al₂O₃ | 45.28 | 19.9 | 2.27 |
| χ-Al₂O₃ | 36.07 | 19.9 | 1.81 |

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A Molybdenum/Technetium 99-m generator comprising:
a metal-molybdate (Mo) containing powder; and
a guard filter comprising an alumina.

2. The Molybdenum/Technetium 99-m generator according to claim 1, wherein the alumina is selected from the group consisting of a gamma-phase aluminum oxide (γ-Al₂O₃), a chi-phase aluminum oxide (χ-Al₂O₃), and a combination thereof.

3. The Molybdenum/Technetium 99-m generator according to claim 1, wherein the guard filter further comprises a material selected from the group consisting of MSU-X mesoporous alumina, Polymeric Titania Compound (PTC), Polymer Embedded Nanocrystalline Titania, Polymeric Zirconia Compound (PZC), Tetragonal Nano Zirconia, chitosan-based products, iron, activated carbon, and a combination thereof.

4. A Molybdenum/Technetium 99-m generator comprising:
a metal-molybdate containing powder; and
a gamma-phase aluminum oxide (γ-Al₂O₃).

5. The Molybdenum/Technetium 99-m generator according to claim 4, wherein the Molybdenum/Technetium 99-m generator comprises a column.

6. The Molybdenum/Technetium 99-m generator according to claim 5, wherein the column comprises a Mo powder bed containing the metal-molybdate containing powder.

7. The Molybdenum/Technetium 99-m generator according to claim 5, wherein the column comprises a guard filter bed containing the gamma-phase aluminum oxide (γ-Al₂O₃).

8. The Molybdenum/Technetium 99-m generator according to claim 7, wherein the guard filter bed further comprises a material selected from the group consisting of MSU-X mesoporous alumina, Polymeric Titania Compound (PTC), Polymer Embedded Nanocrystalline Titania, Polymeric Zirconia Compound (PZC), Tetragonal Nano Zirconia, chitosan-based products, iron, activated carbon, and a combination thereof.

9. The Molybdenum/Technetium 99-m generator according to claim 7, wherein the guard filter bed has a bed height (Length) and a column inner diameter (D) in a ratio of L/D in a range of 0.25 to 10.

10. The Molybdenum/Technetium 99-m generator according to claim 4, wherein a mass ratio of the gamma-phase aluminum oxide to the metal-molybdate powder (Al:P) is in a range of 0.025:1 to 5:1.

11. A Molybdenum/Technetium 99-m generator comprising:
a metal-molybdate containing powder; and
a chi-phase aluminum oxide (χ-Al₂O₃).

12. The Molybdenum/Technetium 99-m generator according to claim 11, wherein the Molybdenum/Technetium 99-m generator comprises a column.

13. The Molybdenum/Technetium 99-m generator according to claim 12, wherein the column comprises a Mo powder bed containing the metal-molybdate containing powder.

14. The Molybdenum/Technetium 99-m generator according to claim 12, wherein the column comprises a guard filter bed containing the chi-phase aluminum oxide (χ-Al₂O₃).

15. The Molybdenum/Technetium 99-m generator according to claim 14, wherein the guard filter bed further comprises a material selected from the group consisting of MSU-X mesoporous alumina, Polymeric Titania Compound (PTC), Polymer Embedded Nanocrystalline Titania, Polymeric Zirconia Compound (PZC), Tetragonal Nano Zirconia, chitosan-based products, iron, activated carbon, and a combination thereof.

16. The Molybdenum/Technetium 99-m generator according to claim 14, wherein the guard filter bed has a bed height (Length) and a column inner diameter (D) in a ratio of L/D in a range of 0.25 to 10.

17. The Molybdenum/Technetium 99-m generator according to claim 11, wherein a mass ratio of the chi-phase aluminum oxide to the metal-molybdate powder (Al:P) is in a range of 0.025:1 to 5:1.

18. A method of using, the method comprising:
introducing a guard filter comprising an alumina selected from the group consisting of γ-Al₂O₃, χ-Al₂O₃, and a combination thereof into a Molybdenum/Technetium 99-m generator, the Molybdenum/Technetium 99-m generator comprising a metal-molybdate (Mo) containing powder.

19. The method of using according to claim 18, wherein the guard filter further comprises a material selected from the group consisting of MSU-X mesoporous alumina, Polymeric Titania Compound (PTC), Polymer Embedded Nanocrystalline Titania, Polymeric Zirconia Compound (PZC), Tetragonal Nano Zirconia, chitosan-based products, iron, activated carbon, and a combination thereof.

20. The method of using according to claim 18, wherein the guard filter has a pH in a range of 3.5 to 7.5.
